(19) United States
(12) Patent Application Publication
(10) Pub. No.: US 2009/0205243 A1
(43) Pub. Date: Aug. 20, 2009

(54) BAITFISH HOLDER FISHING JIG

(76) Inventor: John Morton Calderwood, South Australia (AU)

Correspondence Address: WILLIAM J. SAPONE;COLEMAN SUDOL SAPONE P.C., 714 COLORADO AVENUE, BRIDGE PORT, CT, 06605, US

(21) Appl. No.: 12/093,350

(22) PCT Filed: Oct. 25, 2006
(86) PCT No.: PCT/AU2006/001588

§ 371 Date: Jul. 14, 2008

(30) Foreign Application Priority Data
Dec. 2, 2005 (AU) 2005906731

(51) Int. Cl. A01K 83/00; A01K 83/06

(52) U.S. Cl. 43/44.8; 43/44.2

(57) ABSTRACT

A fishing jig able to hold a baitfish, the jig including a primary shaft having a fishing line attachment end and a bifurcated free end, the free end supporting opposed hook assemblies in a manner such that each hook assembly is offset from the primary shaft. The primary shaft is preferably long enough for the jig to be able to skewer a baitfish, to thereby hold the baitfish generally centrally, with the attachment end projecting out of the baitfish at or near its head and the bifurcated free end (and opposed hook assemblies) projecting out of the baitfish at or near its tail.

### FIELD OF THE INVENTION

The present invention relates to fishing jigs of the type that are used to hold a baitfish, particularly those baitfish jigs that are used by anglers to catch squid and cuttlefish and are thus often simply referred to as “squid jigs”.

### BACKGROUND OF THE INVENTION

A fishing lure is any type of device that attracts, entices or allures a predatory aquatic animal, normally a fish but often also a squid or cuttlefish, so that an angler can catch that fish using whatever hook(s) also form part of the lure. Within this strict literal definition, some “lures” are actually nothing more than an unbaited (single) hook, or perhaps are an arrangement of unbaited hooks (often simply referred to as “jigs”).

When fishing with baitfish, most anglers would normally use a simple hook, with the shaft of the hook carrying the baitfish and the barbed end of the hook being exposed beyond the body of the baitfish. Alternatively, an angler would use a custom-made jig, such as a series of ganged hooks, secured using special techniques along the body of the baitfish.

When fishing with baitfish for squid or cuttlefish, different arrangements of hooks are often used, many that utilize a plurality of sharpened (barbless) pins that together form a hook assembly, the hook assembly being secured to the end of an elongate shaft. Sometimes these hook assemblies are referred to as being in an umbrella arrangement, as they take on the general appearance of the frame members of an inverted umbrella. In this respect, it will be noted that in fact most commercially available squid jigs are not intended for use with baitfish, but rather replace the elongate shaft with a body portion, the body portion being artificial and resembling a baitfish (such as a small plastic fish or plastic prawn or the like).

In either form of squid jig, the hook assembly is, in use, left exposed, usually at one end of a baitfish mounted on the jig (or at one end of the artificial baitfish), with the aim of having the baitfish attract a squid and the exposed hook assembly catch the squid for retrieval by the angler. Often when baitfish are used, the exposed hook assembly is at the head end of the baitfish.

However, the present inventor has found that squid jigs of this general type, namely with exposed hook assemblies, often seem to frighten squid and cuttlefish. Indeed, the present inventor has found that the use of a baitfish with no hook assembly whatsoever was a highly successful technique for luring squid and cuttlefish. This, of course, did not lead to fishing success as the squid and cuttlefish could not be caught unless they subsequently took a second jig placed near them in the water once they have been attracted. It did though lead the present inventor to conclude that the presence of the fully exposed hook assemblies was reducing the likelihood of success in catching squid and cuttlefish.

It is an aim of the present invention to provide an improved fishing jig that, while including a hook assembly, reduces the exposure of the hook assembly when used with baitfish.

Before turning to a summary of the present invention, it must be appreciated that the above description of the prior art has been provided merely as background to explain the context of the invention. It is not to be taken as an admission that any of the material referred to was published or known, or was a part of the common general knowledge in Australia or elsewhere.

Also, in the following description, reference will often be made just to squid, as being the angler's target aquatic animal. This is being done merely for the sake of clarity, and the present invention is of course not to be limited to being a fishing jig only for use in fishing for squid.

### SUMMARY OF THE INVENTION

The present invention provides a fishing jig able to hold a baitfish, the jig including a primary shaft having a fishing line attachment end and a bifurcated free end, the free end supporting opposed hook assemblies in a manner such that each hook assembly is offset from the primary shaft.

The primary shaft is preferably long enough for the jig to be able to skewer a baitfish, to thereby hold the baitfish generally centrally, with the attachment end projecting out of the baitfish at or near its head and the free end projecting out of the baitfish at or near its tail. The attachment end of the primary shaft may include a sharpened or semi-sharpened portion to assist in skewering the baitfish, and then to assist in passing the primary shaft through the baitfish.

In use, the primary shaft will preferably be inserted far enough into the baitfish so that the bifurcated portion at the free end abuts against the baitfish (at or near its tail), preventing further passage of the jig into or through the baitfish. In this position, the offset configuration of the hook assemblies (and thus the spacing therebetween) will preferably cause each hook assembly to be located closely adjacent opposing sides of the tail of the baitfish. Most preferably, the opposing sides will be the dorsal and ventral sides of the baitfish, but the opposing sides may be the left and right sides on the flanks of the baitfish.

Thus, one hook assembly will preferably be located closely adjacent the dorsal side (or the back) of the baitfish, behind the dorsal fin but before the tail fin, while the other hook assembly will preferably be located closely adjacent the ventral side (or underside) of the baitfish, behind the ventral (or anal) fin but before the tail fin.

By ensuring that the hook assemblies are located, in use, in these regions, there is an increased likelihood that predators such as squid will not recognize the presence of the hook assemblies. Indeed, the expectation is that the hook assemblies will appear to a squid to be a part of the normal fins of the baitfish, and thus the hook assemblies are each likely to be reasonably well camouflaged. In this respect, it will thus be appreciated that the most preferred location for the hook assemblies will be closely adjacent to either or both of the dorsal and ventral fins respectively of the baitfish, or closely adjacent to the tail fin of the baitfish.

In a preferred form, the bifurcated free end of the primary shaft is provided by a T-shaped end portion, with each of the top arms of the T supporting a respective hook assembly at or towards their ends. Therefore, the length of those top arms will dictate the distance that each hook assembly is offset from the primary shaft, and thus will dictate the spacing between the hook assemblies. Given the preferred location of the hook assemblies mentioned above (with regard to the dorsal and ventral regions of a baitfish), this spacing will necessarily be different for jigs to be used with different sized baitfish. Thus, it is envisaged that different sized jigs would be provided, both in terms of the length of their shafts and also in terms of the spacing between hook assemblies.

The hook assemblies themselves are each likely to be configured identically, principally for ease of manufacture, although this need not be the case. However, the following general description of the hook assemblies will, for the sake of clarity, be a description of only one hook assembly.

In a preferred form, a hook assembly will include a plurality of pins arranged about a secondary shaft, preferably at or towards the end of the secondary shaft. In this respect, it is possible (although not preferred) for the pins to be arranged part way along the secondary shaft such as towards the middle thereof.

The pins are preferably configured to extend away from the secondary shaft, generally towards the attachment end of the primary shaft. This arrangement might be referred to as providing a semi- or half-umbrella configuration of pins. Preferably the pins will be sharpened (such as chemically sharpened) and barbless.

The plurality of pins may be provided as two or more series of pins, with one series arranged about the secondary shaft forming an arc of pins, and a second series of smaller pins also arranged about the secondary shaft but located inside the first series and thus forming a second arc. This dual series arrangement then provides two tiers of pins within one hook assembly.

A hook assembly is preferably supported at the free end of one of the top arms of the T-shaped end portion mentioned above. The hook assembly is preferably supported such that its secondary shaft extends either generally parallel to the primary shaft or at a slight incline towards the primary shaft (perhaps inclined in more than one plane). The secondary shaft itself includes a free end that is towards the attachment end of the primary shaft and a supported end, the arrangement of pins mentioned above preferably being at the supported end.

The secondary shaft of a hook assembly is also preferably sharpened at its free end. It is envisaged that in most situations the free end of a hook assembly will pierce the body of the baitfish to assist in securing the jig in place (and the baitfish upon the jig). Thus, the secondary shaft of one of the hook assemblies will preferably pierce the baitfish near the dorsal side thereof, while the secondary shaft of the other hook assembly will preferably pierce the baitfish near the ventral side thereof.

Furthermore, in a preferred form, one of the secondary shafts will ideally be longer than the other secondary shaft, in order to assist in loading the baitfish onto the fishing jig. In this respect, it is likely to be easier in most instances to pierce the baitfish with one secondary shaft before the other, to avoid having to manage such piercing in two locations at once.

Therefore, it can also be said that the present invention provides a fishing jig able to hold a baitfish, the jig including a primary shaft having a fishing line attachment end and a bifurcated free end, the free end supporting opposed hook assemblies in a manner such that each hook assembly is offset from the primary shaft, wherein the primary shaft is long enough for the jig to be able to skewer a baitfish, to thereby hold the baitfish generally centrally, with the attachment end projecting out of the baitfish at or near its head and the free end projecting out of the baitfish at or near its tail.

Similarly, the present invention provides a fishing jig able to hold a baitfish, the jig including a primary shaft having a fishing line attachment end and a bifurcated free end, the free end supporting opposed hook assemblies in a manner such that each hook assembly is offset from the primary shaft, wherein the primary shaft is long enough for the jig to be able to skewer a baitfish, to thereby hold the baitfish generally centrally, with the attachment end projecting out of the baitfish at or near its head and the free end projecting out of the baitfish at or near its tail, and wherein each hook assembly includes a plurality of pins arranged about a secondary shaft, the pins being configured to extend away from the secondary shaft, generally towards the attachment end of the primary shaft

### BRIEF DESCRIPTION OF THE DRAWINGS

Having briefly described the general concepts involved with the present invention, a preferred embodiment will now be described that is in accordance with the present invention. However, it is to be understood that the following description is not to limit the generality of the above description.

In the drawings:

FIG. 1 is a perspective view from the free end of a fishing jig in accordance with a preferred embodiment of the present invention;

FIG. 2 is plan view of the embodiment of FIG. 1;

FIG. 3 is an end view of the embodiment of FIG. 1;

FIG. 4 is a schematic side view of the embodiment of FIG. 1 in use with a baitfish.

### DESCRIPTION OF A PREFERRED EMBODIMENT

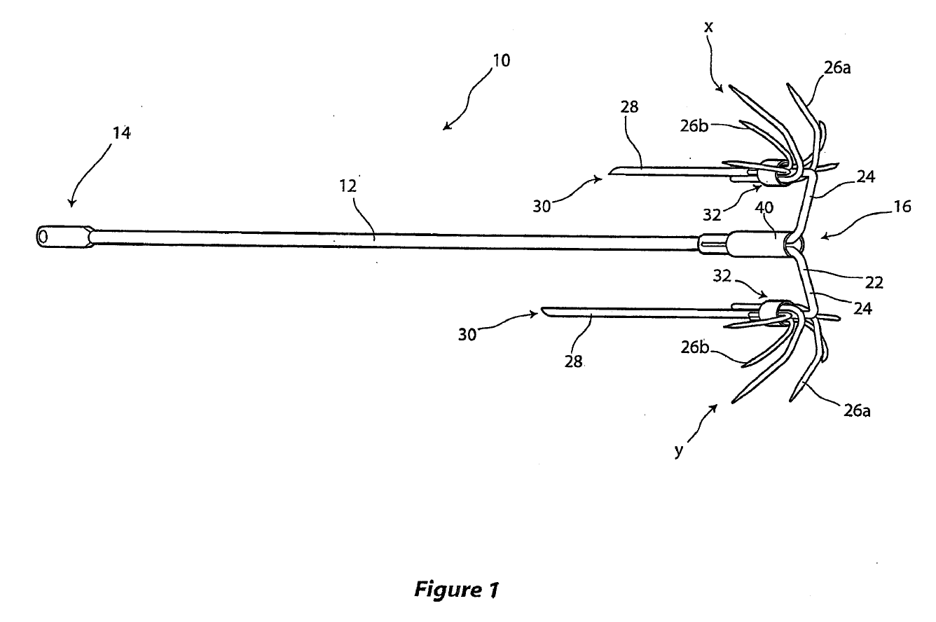

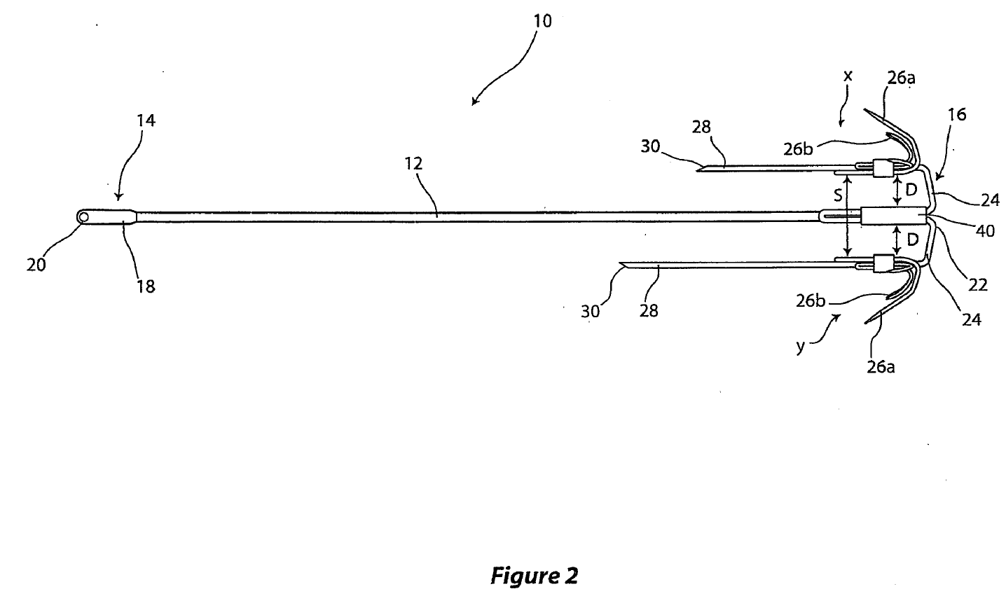

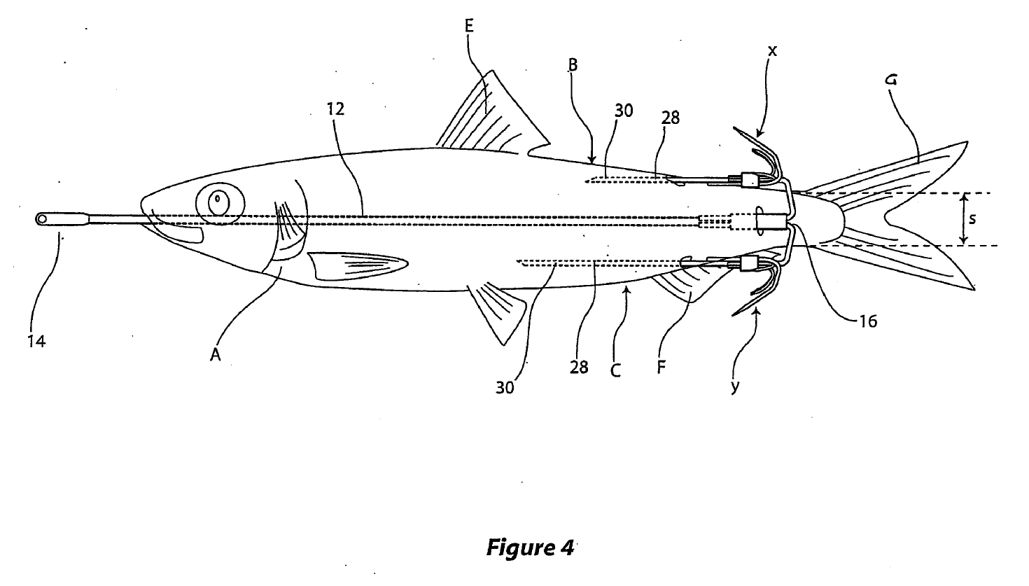

Illustrated in FIGS. 1 and 2 is a fishing jig 10 able to hold a baitfish (as shown in FIG. 4 by the reference A) for the purpose of attracting and catching an aquatic animal, such as a squid or a cuttlefish.

The jig 10 includes a primary shaft 12 that has a fishing line attachment end 14 and a bifurcated free end 16. At the attachment end 14 is a flattened portion 18 through which there is a fishing line attachment aperture 20. It will be appreciated that any suitable form of aperture or structure may be provided at the attachment end 14 for the purpose of attaching fishing line to the jig 10.

It will also be appreciated, given the use of the jig 10, that it will be advantageous to form the attachment end 14 so as to be sharpened, or semi-sharpened, so as to assist in the passage of the primary shaft 12 into the baitfish A when loading the baitfish A onto the jig 10. In the embodiment illustrated in FIGS. 1 and 2, that semi-sharpening is provided by the flattening of the attachment end 14 to form the flattened portion 18.

The bifurcated free end 16 of the primary shaft 12 supports opposed hook assemblies X,Y in a manner such that each hook assembly X,Y is offset from the primary shaft 12 by a distance D. The bifurcated free end 16 is provided by a T-shaped end portion 22, with each of the top arms 24 of the T supporting a respective hook assembly X,Y at or towards their ends. Therefore, the length of those top arms 24 dictate the distance D that each hook assembly X,Y is offset from the primary shaft 12, and thus will dictate the spacing S between the hook assemblies X,Y.

Each hook assembly X,Y includes a plurality of pins 26a,26b arranged about a secondary shaft 28, the pins 26a,26b being configured to extend away from the secondary shaft 28, generally towards the attachment end 14 of the primary shaft 12. In this respect, the reference to the pins 26a,26b extending generally towards the attachment end 14 can be seen to be a very general indication that the pins are angled back towards that end of the jig 10 so as to form a reasonably shallow U-shaped interior, as opposed to a reasonably sharp V-shaped interior. The reasonably shallow U-shape interior is advantageous as it has been found that, with pin arrangements that present more with a V-shaped interior, the V tends to introduce a scissors-type action and can sever (rather than catch) squid tentacles that are trapped thereby. In contrast, the U tends to avoid this scissors-type action.

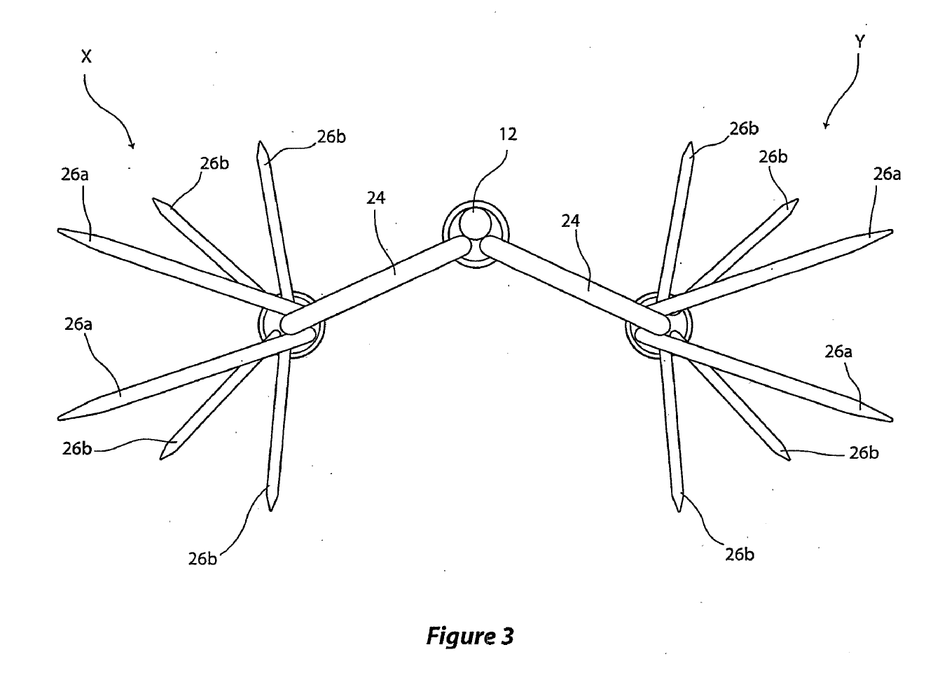

Each hook assembly X,Y is shown with two series of pins, being pins 26a and pins 26b, where the first series or pins 26a arranged about the secondary shaft 28 forms an arc of pins, and the second series of smaller pins 26b, located inside the first series of pins 26a, thus forms a second arc of pins. In the embodiment illustrated in FIGS. 1 and 2, the first series of pins 26a includes only two pins, whereas the second series of smaller pins 26b includes four pins. These arrangements of pins are more evident in the end view of the jig 10 shown in FIG. 3.

As can be seen, each hook assembly X,Y is supported at the free end of one of the top arms 24 of the T-shaped end portion 16. For example, the hook assembly X is supported such that its secondary shaft 28 extends at a slight incline towards the primary shaft 12 in one plane (being the plane of the drawing sheet of FIG. 4, and as is evident in FIG. 4) and also slightly away from the primary shaft 12 (such as into the drawing sheet of FIG. 4 and towards the spine of the baitfish). The secondary shaft 28 includes a free end 30 that is towards the attachment end 14 of the primary shaft 12 and a supported end 32, the arrangements of pins 26a,26b being at the supported end 32. Also, the secondary shaft 28 is sharpened at its free end 30.

In the embodiment shown in FIGS. 1 to 3, the jig 10 of the present invention is formed from a reasonably fine gauge stainless steel. The primary shaft 12 is a single elongate piece of stainless steel wire, which is crimped by a sleeve 40 to another elongate piece of stainless steel wire bent so as to form the arms 24 of the T-shaped portion that forms the bifurcation at the free end 16 and also the secondary shafts 28 of the hook assemblies X,Y. It will of course be appreciated that any suitable configuration of members could be used to form the various parts of the jig 10 of the present invention, and that the use of single pieces of stainless steel bent in this fashion is not essential to the invention. This is also the case of course for the manner in which the pins 26a, 26b are formed and configured. Furthermore, it is envisaged that some or all of the jig 10 of the present invention may be formed by injection moulding suitable plastic materials. Indeed, it is envisaged that the entire jig 10 might be injection moulded in a suitable plastic in one piece.

With reference to FIG. 4, the primary shaft 12 (shown in broken lines within the body of a baitfish A) is long enough for the jig 10 to be able to skewer a baitfish A, to thereby hold the baitfish A generally centrally, with the attachment end 14 projecting out of the baitfish A at or near its head and the free end 16 projecting out of the baitfish at or near its tail.

In use the primary shaft 12 will be inserted far enough into the baitfish A so that the bifurcated portion at the free end 16 abuts against the baitfish A (near its tail fin G), preventing further passage of the jig 10 into or through the baitfish A. In this position, the offset configuration of the hook assemblies X,Y (and thus the spacing S therebetween) causes each hook assembly X,Y to be located closely adjacent opposing sides of the tail of the baitfish A. As can be seen in FIG. 4, one hook assembly X can thus be located closely adjacent the dorsal side B (or the back) of the baitfish A, behind the dorsal fin E but before the tail fin G, while the other hook assembly Y can be located closely adjacent the ventral side C (or underside) of the baitfish A, behind the ventral (or anal) fin F but before the tail fin G.

Also, the free ends 30 of the secondary shafts 28 of each hook assembly X,Y have also pierced the body of the baitfish A to assist in securing the jig 10 in place (and the baitfish A upon the jig 10), noting that this is made somewhat easier by forming the two secondary shafts 28 of different length (as mentioned above). The secondary shaft 28 of the hook assembly X has pierced the baitfish A near the dorsal side B thereof, while the secondary shaft 28 of the other hook assembly Y has pierced the baitfish A near the ventral side C thereof. This assists in the preferred location of the hook assemblies X,Y as mentioned above, and also assists in preventing rotation of the jig 10 in use about the primary shaft 12, and the subsequent movement of the hook assemblies X,Y away from their preferred locations.

Given the preferred location of the hook assemblies X,Y mentioned above (with regard to the dorsal and ventral regions of a baitfish A), the spacing S will necessarily be different for jigs 10 to be used with different sized baitfish A.

As mentioned above, by ensuring that the hook assemblies X,Y are located, in use, in these dorsal and ventral regions, there is an increased likelihood that predators such as squid will not recognize the presence of the hook assemblies X,Y. Indeed, the expectation is that the hook assemblies X,Y will appear to a squid to be a part of the normal fins of the baitfish A, and thus the hook assemblies X,Y are each likely to be reasonably well camouflaged.

In conclusion, it must be appreciated that there may be other variations and modifications to the configurations described herein which are also within the scope of the present invention.

1. A fishing jig able to hold a baitfish, the jig including a primary shaft having a fishing line attachment end and a bifurcated free end, the free end supporting opposed hook assemblies in a manner such that each hook assembly is offset from the primary shaft.

2. A fishing jig according to claim 1, wherein the primary shaft is long enough for the jig to be able to skewer a baitfish, to thereby hold the baitfish generally centrally, with the attachment end projecting out of the baitfish at or near its head and the free end projecting out of the baitfish at or near its tail.

3. A fishing jig according to claim 1, wherein the attachment end of the primary shaft includes a sharpened or semi-sharpened portion.

4. A fishing jig according to claim 1, wherein each hook assembly includes a plurality of pins arranged about a secondary shaft, the pins being configured to extend away from the secondary shaft, generally towards the attachment end of the primary shaft.

5. A fishing jig according to claim 4, wherein the pins are sharpened and barbless.

6. A fishing jig according to claim 4, wherein the plurality of pins are provided as two or more series of pins, with one series arranged about the secondary shaft forming a first arc of pins, and a second series of smaller pins also arranged about the secondary shaft but located inside the first series and thus forming a second arc of pins.

7. A fishing jig according to claim 4, wherein each hook assembly is supported such that its secondary shaft extends at a slight incline towards the primary shaft in at least one plane.

8. A fishing jig according to claim 4, wherein each hook assembly is supported such that its secondary shaft extends generally parallel to the primary shaft.

9. A fishing jig according to claim 4, wherein each secondary shaft includes a free end that is towards the attachment end of the primary shaft and a supported end, the plurality of pins being at or towards the supported end.

10. A fishing jig according to claim 9, wherein the free end of each secondary shaft is sharpened.

11. A fishing jig according to claim 1, wherein the bifurcated free end of the primary shaft is provided by a T-shaped end portion, with each of the top arms of the T supporting a respective hook assembly at or towards their ends.

12. A fishing jig according to claim 11, wherein each hook assembly is supported at a free end of one of the top arms of the T-shaped end portion.

13. (canceled)

14. A fishing jig able to hold a baitfish, the jig including a primary shaft having a fishing line attachment end and a bifurcated free end, the free end supporting opposed hook assemblies in a manner such that each hook assembly is offset from the primary shaft, wherein the primary shaft is long enough for the jig to be able to skewer a baitfish, to thereby hold the baitfish generally centrally, with the attachment end projecting out of the baitfish at or near its head and the free end projecting out of the baitfish at or near its tail.

15. (canceled)

16. A fishing jig able to hold a baitfish, the jig including a primary shaft having a fishing line attachment end and a bifurcated free end, the free end supporting opposed hook assemblies in a manner such that each hook assembly is offset from the primary shaft, wherein the primary shaft is long enough for the jig to be able to skewer a baitfish, to thereby hold the baitfish generally centrally, with the attachment end projecting out of the baitfish at or near its head and the free end projecting out of the baitfish at or near its tail, and wherein each hook assembly includes a plurality of pins arranged about a secondary shaft, the pins being configured to extend away from the secondary shaft, generally towards the attachment end of the primary shaft.

17. (canceled)
